(19) United States
(12) Patent Application Publication
(10) Pub. No.: US 2008/0235143 A1
(43) Pub. Date: Sep. 25, 2008

(54) Real time data tunneling for utility monitoring web applications

(75) Inventors: Jeffrey Lee Beller, Murfreesboro, TN (US); Timothy Greg Curray, Murfreesboro, TN (US)

Correspondence Address: SCHNEIDER ELECTRIC / SQUARE D COMPANY;LEGAL DEPT. - I.P. GROUP (NP), 1415 S. ROSELLE ROAD, PALATINE, IL, 60067, US

(73) Assignee: Square D Company

(21) Appl. No.: 11/725,675

(22) Filed: Mar. 20, 2007

(51) Int. Cl. H04L 9/32

(52) U.S. Cl. 705/63

(57) ABSTRACT

A method and system to provide web-based real-time monitoring data from an electrical power system. An example method provides real-time data from an electrical power system via a web server to web based client. The web server is accessed to receive a webpage interface. Data is sensed via a monitoring device in the electrical power system. The sensed data is requested by the web-based client. The sensed data is transmitted over a network via an open port to the webpage interface of the web-based client. The sensed data is displayed on the webpage interface without reloading the webpage

### FIELD OF THE INVENTION

This invention relates to data tunneling, and, more specifically, to real-time data tunneling for utility monitoring web applications.

### BACKGROUND OF THE INVENTION

Since the introduction of electrical power distribution systems in the late 19th century, there has been a need to monitor their operational and electrical characteristics. The ability to collect, analyze, and respond to information about the electrical power system can improve safety, minimize equipment loss, decrease scrap, and ultimately save time and money. To that end, monitoring devices were developed to measure and report such information. With the dawn of the electronics age, the quality and quantity of data from monitoring devices was vastly improved, and communications networks and software were developed to collect, display and store information.

Effectively monitoring today's electrical power distribution systems has been aided by open network standards such as those used over the Internet. Thus, various electrical components such as circuit breaker banks now have embedded web servers that allow communication of monitored data over the Internet. Clients who desire information may access the monitored data with a web-browser device, thus greatly facilitating access to power monitoring data. However, the need to obtain real-time data in power monitoring systems is essential to various functions. The web-based solutions are not optimal for real-time data because the webpages require updating on a periodic basis resulting in heavy data exchange over the network and refreshing of the display screen in a manner that is visible to the operator.

Traditionally, web-based solutions for power monitoring gathered real-time data according to two approaches. The first approach was to re-load memory and resource-heavy HTML webpage(s) each time a data refresh schedule occurred or when a user requested viewing different data sets. Such HTML pages have server side includes (SSIs) that trigger server side execution to gather the real-time data. Data transfer under this approach requires heavy reload and added burdens on the server as updates to data may be desired every second or number of seconds. The ModbusTCP/IP format is employed as a second method for the data transfer mechanism from the monitoring system server to a client to prevent the heavy reloads. TCP stands for Transmission Control Protocol and IP stands for Internet Protocol. Modbus is an open serial communications protocol that was initially developed by Modicon, which is now owned by the assignee of the present invention.

The ModbusTCP/IP solution is typically deployed on small, private local area networks (LANs) but has unacceptable side-effects. For example, when deployed on larger wide area networks (WANs), ModbusTCP/IP packets are typically blocked by security countermeasures such as firewalls. The ModbusTCP/IP format uses TCP port 502 that is typically a closed port by default in most WAN infrastructure deployments. This is typically a roadblock for ease of deployment for customers. Another side-effect is the deployment of the ModbusTCP/IP client components onto the users' browsers. The deployments of the components were prone to issues relating to the ever growing security constraints being enabled on web-browsers.

Thus, the current methods for real-time data communications between web-browsers and embedded web servers for power monitoring applications have been lacking in capturing the right complement of speed versus network infrastructure interoperability. There is currently no way that power monitoring systems can transport real-time data between web-browsers and embedded web servers efficiently and effectively matching the performance required and addressing these network infrastructure interoperability issues.

What is needed, therefore, is a web-based interface for remote reception of real-time data from a power monitoring system. There is a further need for a web-based interface that receives and updates power monitoring data without refreshing a webpage. There is also a need for a web-based interface that allows data to be exchanged without the need to unblock security measures. Aspects of the present invention are directed to satisfying these and other needs.

### SUMMARY OF THE INVENTION

Briefly, one example disclosed is a method of providing real-time data from an electrical power system via a web server to a web-based client. The web server is accessed to receive and load a webpage interface on the web-based client. Power-related data from at least one power monitoring device in the electrical power system is received at the web server. The power-related data is representative of electrical characteristics sensed by the at least one power monitoring device. The power-related data is communicated over a network to the webpage interface. The power-related data is displayed on the webpage interface without reloading the webpage from the web server.

Another example disclosed is a web server to communicate real-time data between an electrical power system and a web based client. The electrical power system includes a plurality of power monitoring devices. The web server includes a data interface coupled to the plurality of power monitoring devices. The data interface receives power-related data captured by at least one of the plurality of power monitoring devices in the electrical power system. The power-related data is representative of electrical characteristics sensed by the at least one of the plurality of power monitoring devices. A server data engine is coupled to the data interface and receives the power-related data and transmits a webpage interface to a requesting web client in network communication with the web server. The web client displays the webpage interface and receives the power-related data from the web server after the web page interface is transmitted. The web page interface displays the received power-related data without reloading the web page interface from the server data engine.

Another example disclosed is a web client application to obtain real-time data from a power monitoring system including a monitoring device. The application has a display interface to provide a user a graphic display including electrical data from the monitoring device. A client data engine is coupled to the display interface. The client data engine receives the electrical data via a remote web server coupled to the monitoring device. The client data engine provides the electrical data to the display interface without reloading the web interface.

The foregoing and additional aspects of the present invention will be apparent to those of ordinary skill in the art in view of the detailed description of various embodiments, which is made with reference to the drawings, a brief description of which is provided next.

### BRIEF DESCRIPTION OF THE DRAWINGS

The foregoing and other advantages of the invention will become apparent upon reading the following detailed description and upon reference to the drawings.

FIG. 1 is functional block diagram of an electrical utility system with a web-server based monitoring system in accordance with an aspect of the present invention;

FIG. 2 is a functional block diagram of components of the web-based monitoring system of FIG. 1 to provide real-time data to a client web-browser device according to an aspect of the present invention;

FIG. 3 is a screen shot of an example web-based interface that displays real-time data obtained from the web-based server in FIG. 1;

FIGS. 4A-4B are a flow chart diagram of a client-side process of obtaining real-time data from the web server device in the system in FIG. 1, according to an aspect of the present invention; and

FIGS. 4C-4D are a flow chart diagram of a server-side process of obtaining real-time data to be transferred to the client web-enabled device, in the system in FIG. 1, according to an aspect of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF THE ILLUSTRATED EMBODIMENTS

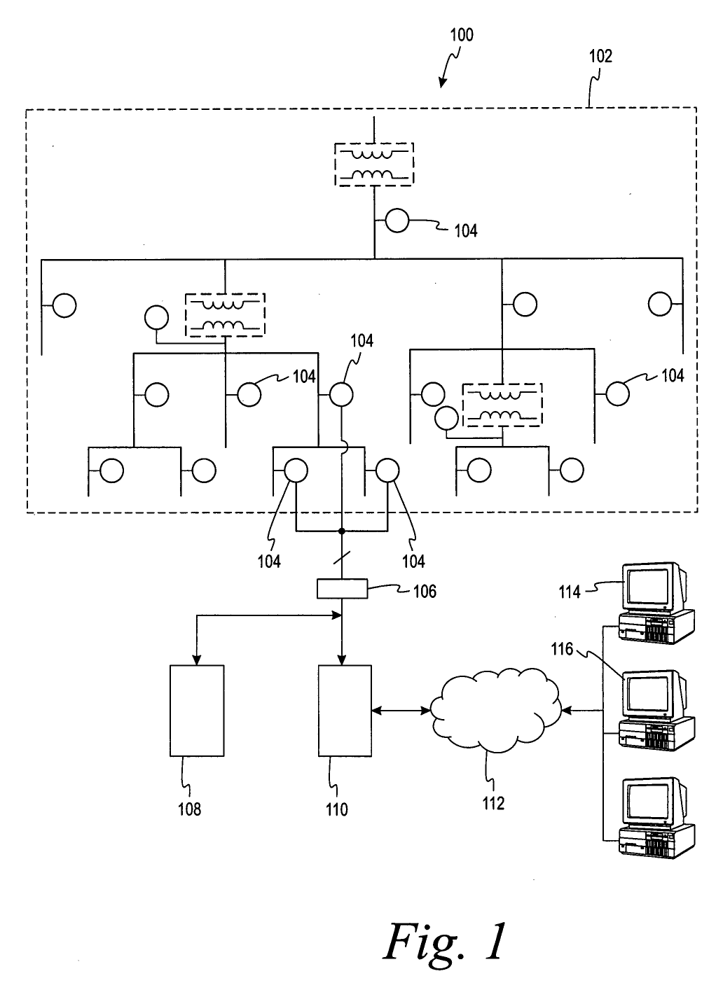

Turning now to FIG. 1, a web-based power monitoring system 100 for a power system is generally shown. A utility system 102 having multiple monitoring devices 104 provides data from each monitoring device 104 that is communicated to a data interface 106. The data may be aligned automatically in the data interface 106 with the system hierarchy and temporally aligned such that it represents the data when it was actually seen simultaneously by the monitoring devices 104 in the power data monitoring system 100. A system and method for automatically determining the hierarchy of a power system is described in commonly assigned, co-pending U.S. patent application Ser. No. 11/174,100, filed Jul. 1, 2005, entitled “Automated Hierarchy Classification in Utility Monitoring Systems,” the entirety of which is incorporated herein by reference in its entirety. Alternatively, the hierarchy of the electrical power system 100 may be entered manually by a user or be already known. A system and method for automatically aligning data in a utility monitoring system is described in commonly assigned, co-pending U.S. patent application Ser. No. 11/174,099, filed Jul. 1, 2005, entitled “Automated Precision Alignment of Data in a Utility Monitoring System,” the entirety of which is incorporated herein by reference in its entirety.

An example of an implementation for automatically determining the hierarchy of the electrical power system, or how N monitoring devices are directly or indirectly linked in a distribution system includes receiving at time intervals device data measured by each of monitoring devices. The implementation calculates from the device data a first correlation coefficient between a reference device and every other device in the distribution system to produce N-1 correlation coefficients. The implementation determines the highest correlation coefficient among the N-1 correlation coefficients. Responsive thereto, the implementation automatically determines whether the device associated with the highest correlation coefficient and the reference device are linked. If that automatic determination determines that the device associated with the highest correlation coefficient is linked to the reference device, then the implementation stores second data representing that the device associated with the highest correlation coefficient and the reference device are linked.

An example of an implementation for automatically aligning the data associated with multiple monitoring devices includes aligning data measured by monitoring devices coupled to a power monitoring system. Reference signal data is received from a reference monitoring device. The reference signal data represents frequency variations measured by the reference monitoring device for a predetermined number of cycles. Second signal data is received from a second monitoring device that measures frequency variations for a predetermined number of cycles. The reference data is automatically aligned with the second signal data.

The utility being monitored in the utility system 102 can be any of the five utilities designated by the acronym, WAGES, or water, air, gas, electricity, or steam. Each monitoring device 104 measures characteristics of the utility, and quantifies these characteristics into data that can be analyzed by a computer. In this example, the monitoring devices 104 may be based on a PowerLogic® Series 3000/4000 Circuit Monitor or a PowerLogic® ION7550/7650 Power and Energy Meter available from Schneider Electric, or any other suitable monitoring device such as a circuit breaker, a metering device, or a power meter. There may also be multiple monitoring devices with the capabilities of the monitoring devices 104 in the utility system 102.

An optional data alignment system 108 aligns data, such as voltage, current, time, events, and the like, from the multiple monitoring devices 104 in the utility system 102 in the data interface 106. When data from all the monitoring devices 104 is aligned to the same point in time that the data occurred, the data can be put into a temporal context from which additional decisions regarding hardware and software configuration can be automatically made or recommended.

The example monitoring devices 104 measure electrical characteristics that are related to electrical power (such as voltage, current, power, energy, harmonics, and the like) associated with electrical devices on each respective line in the utility system 102. Each monitoring device 104 is communicatively coupled via the data interface 106 to a web server 110. In this example, the web server 110 is an embedded web server which may be installed on any appropriate electrical device in the utility system 102. However, it is to be understood that the web server 110 may also be a separate server. The monitoring devices 104 sense the electrical characteristics with one or more sensors and generate power-related data representative of the sensed electrical characteristics. The data interface 106 may be incorporated in the web server 110 or may be a separate unit coupled to the web server 110. The web server 110 is in communication with a network 112. In this example, the network 112 is the Internet, but other networks such as LANs, WANs, etc. using TCP/IP protocols or other similar communications protocols may be employed. The network 112 may be private, such as a private LAN, or public, such as the Internet or other public WAN. As used herein, the term “web” does not necessarily connote a public network but also expressly contemplates private networks. The network 112 allows access via a series of client web-enabled devices 114, which in this example, includes an example personal computer 116 with web-browsing software such as Internet Explorer.

The power monitoring system 100 transports real-time data between web-browser devices such as the client web-enabled device 114 and the embedded web server 110 efficiently and effectively. Real-time power monitoring data taken from the monitoring devices 104 is tunneled through the HTTP protocol utilizing XML (Extensible Markup Language) and JavaScript technologies known as Asynchronous JavaScript and XML (AJAX).

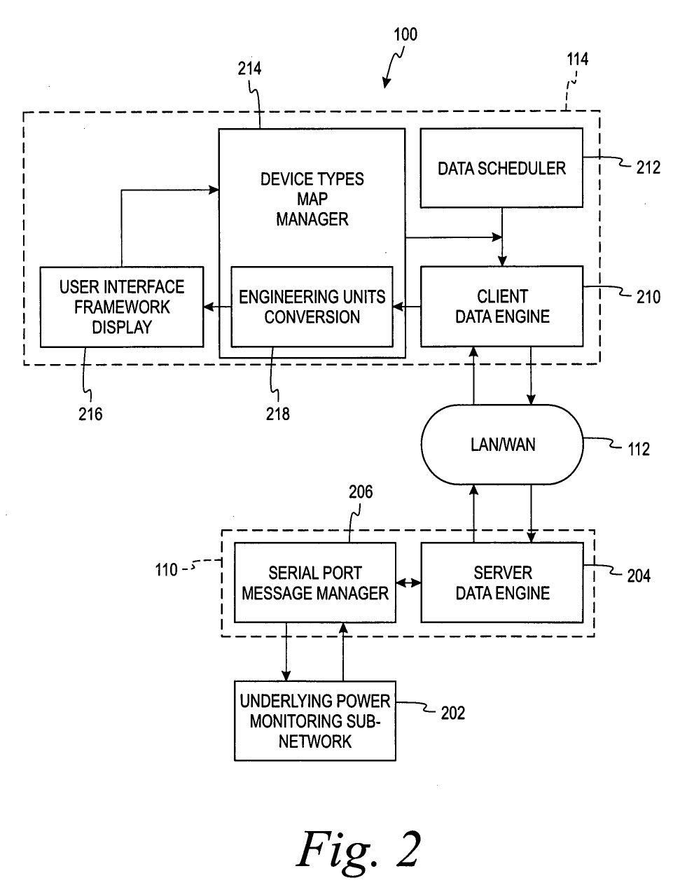

FIG. 2 is a block diagram of components of the power monitoring system 100 for processing real-time data between the web server 110 and the client web-enabled device 114. As shown in FIG. 2, an underlying power monitoring subnetwork 202 includes the monitoring devices 104 and data interface in the utility system 102 and sends data to and receives requests for data from the web server 110. The web server 110 includes a server data engine 204 and a serial port message manager 206. The server data engine 204 manages requests for real-time data from a client such as the client web-enabled device 114 by requesting such data from the monitoring devices 104. Requests for data are sent via a serial port that is coupled to the monitoring devices 104. Requests for data are managed by the serial port message manager 206 that also manages the data received from the monitoring devices 104. The monitoring devices 104 in this example send their data to the server data engine 204 and the serial port message manager 206 based on the Modbus format, but a many other formats such as JBUS or SYMAX may be used. The server data engine 204 converts the data into an Extensible Markup Language (XML) based format in this example. The server data engine 204 communicates with the network 112.

The web client such as the client web-enabled device 114 includes various client-based components such as a client data engine 210, a data scheduler 212, a device types map manager 214, and a user interface framework display 216. The device types map manager 214 also includes an engineering units conversion module 218. It is to be understood that the client-based components 210, 212, 214, 216 and 218 are initially loaded into the web client for access by the browser application. The client-based components 210, 212, 214, 216 and 218 are obtained from the web server 110 via the network 112 upon the user's initial request for viewing data. Once these components are loaded, these components cooperate to tunnel only appropriate data needed from the server data engine 204 as will be explained below.

The client data engine 210 provides local access to power monitoring data for the web client. The data scheduler 212 schedules the frequency that power monitoring data is requested from the server data engine 204. The device types map manager 214 coordinates the types of power monitoring data capable of being requested as well as the formatting of the data. The engineering units conversion component 218 assists data formatting by converting received data into predefined or user-specified units for the interface. The framework display component 216 renders the user interface as a webpage using distinct style sheets and web-based code.

The process of data tunneling allows the exchange of data without having to reload the webpage interface from the web server 110. The data tunneling employs a combination of XHTML (or HTML) and Cascading Style Sheets (CSS) for marking up and styling data received from the web server 110. The client-side scripting language in this example is JavaScript that is run on the browser application on the client web-enabled device 114. The client-side scripting language dynamically displays and interacts with the information presented. The XMLHttpRequest (XHR) object is accessed to make requests for data asynchronously from the web server 110. As explained above, XML is the format for transferring data between the server data engine 204 and the client such as the client web-enabled device 114.

This approach is a web development technique for creating interactive power monitoring web applications needing real-time data. By tunneling the data using the XMLHttpRequest object, the user of the client web-enabled device 114 receives more responsive updates because only small amounts of data are exchanged via the XMLHttpRequest object with the web server 110. This avoids reloading the entire webpage each time the user requests new data or data needs to be refreshed at certain scheduled intervals. This increases the webpage interactivity, speed, view ability, and usability while dramatically reducing the processor demand on the embedded web server 110.

Thus, this approach allows the data transfer to occur in the background web-based communication without the heavy reload and added burden on the web server 110 and the client web-enabled device 114 of the entire webpage that serves as the data interface. Further, such an approach avoids the problems of the ModbusTCP/IP format as the data transfer mechanism from the web server to the web client by using HTTP over the TCP port 80. The TCP port 80 avoids the normal transmission of data via the ModbusTCP/IP format that is communicated via a closed port by default in most WAN infrastructure deployments. The system uses HTTP for the data transfer mechanism via the built-in XMLHttpRequest object component. With the HTTP request, a webpage loaded on the client web-enabled device 114 can make a request for data via the data scheduler 212, and receive a response containing the data from the web server 110 without reloading the entire webpage. The XMLHttpRequest (XHR) is an API (application programming interface) that can be accessed by JavaScript, and other web-browser scripting languages to transfer text or binary data to and from the web server 110 using HTTP, by establishing an independent communication channel between the client-side and the server-side of the webpage interface. Because the independent channel is through the non-firewalled TCP port 80, the data may be freely exchanged in real-time.

The user will stay on the same webpage, and the user will not notice that scripts might request data, or send data requests to the web server in the background. The XMLHttpRequest is sent through TCP port 80 that is typically an open port on most WAN infrastructures due to the commonplace of Internet browser deployments. Because this approach only depends on the access of one TCP port (port 80) and the preexisting component being already installed, the deployment is much easier.

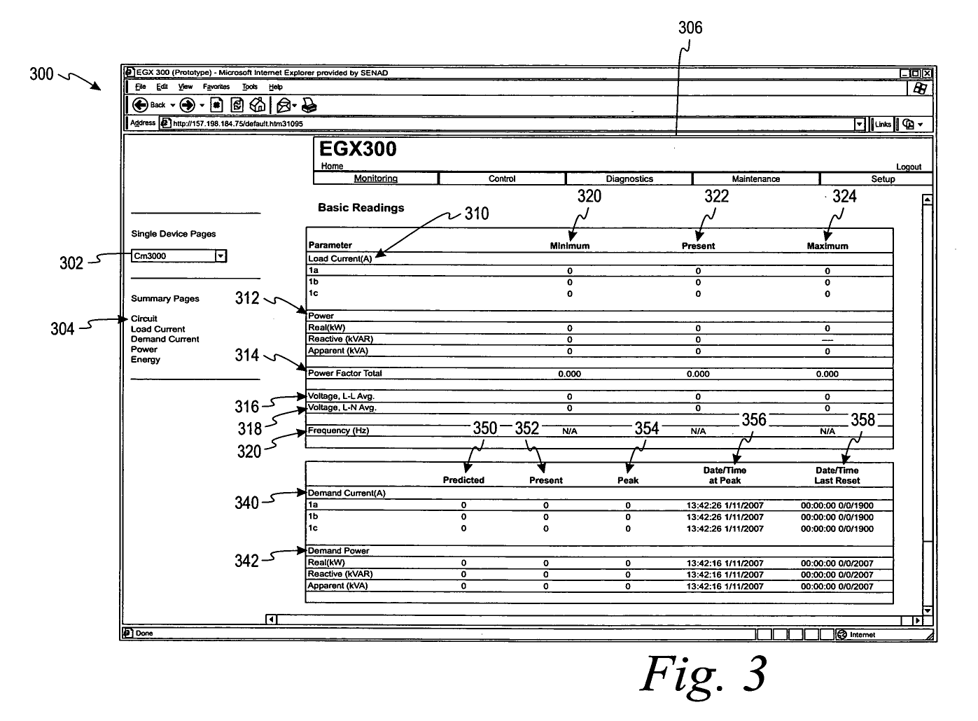

FIG. 3 is a screen shot of a web-based interface 300, which is a webpage using the web-based processes of the power data monitoring system 100 described above. The web-based interface 300 is generated by a browser application that loads on the client web-enabled device 114 shown in FIG. 1. The web-based interface 300 is supported by the loaded client components 210, 212, 214, 216 and 218 in FIG. 2 which schedule data requests from the web server 110 to update the data shown on the interface 300 without refreshing the whole webpage. The interface 300 includes a device selection field 302, a summary link section 304, and a readings area 306. The device selection field 302 allows a user to select the option to receive data from any particular monitoring device 104 on the power data monitoring system 100 in FIG. 1. In this example, the monitoring devices 104 all have a particular identifier that allows a user to isolate data from any monitoring device 104 in the system 100. Assuming hierarchy data is present, the user may place the data received from any particular monitoring device 104 in a spatial context. The summary link section 304 allows a user to select the type of data to be displayed from one or more monitoring devices 104 in a summary table format. The readings area 306 displays data from the selected monitoring device or devices that is updated on a periodic or real-time basis depending on the user preference and control of the scheduler 212. The readings area 306 is part of other selections that allow additional monitoring functions to be performed with the webpage interface 300.

In this example, the readings area 306 has different categories listed such as a Load Current category 310, a Power category 312, a Power Factor Total category 314, a Voltage Line-to-Line Average category 316, a Voltage Line-to-Neutral Average category 318, and a Frequency category 320. Each of the categories 310, 312, 314, 316, 318 and 320 may contain subcategories of data. For example, the Load Current category 310 includes the load currents for each of the three phases of the utility system 102 and the Power category 312 includes real, reactive and apparent power data. The readings area 306 also has a Minimum column 320, a Present column 322 and a Maximum column 324. All of the columns 320, 322 and 324 contain measured data that is requested by the data scheduler 212. As explained above, this data is updated by sending an XMLHttpRequest to the server data engine 204 in FIG. 2. The requested data is formatted in XML and inserted into the webpage components by the interface framework display component 216. The Minimum column 320 shows the minimum reading of the value over a designated period of time while the Maximum column 324 shows the maximum reading of the value over the designated period of time.

Data is also requested for a Demand Current category 340 and a Demand Power category 342. In this example, the data is organized in a Predicted Column 350, a Present column 352, a Peak Column 354, a Date/Time at Peak column 356 and a Date/Time Last Reset column 358. The Demand Current category 340 includes listing the demand current for each of the three phases for the system 100. The Demand Power category 342 includes listing real, reactive and apparent power data. All of the data is requested via the data scheduler component 212 on a periodic basis from the client data engine 210. The Predicted column 350 shows the data value that is predicted as a function of the demand on the utility system 102. The Present column 352 displays the real-time data requested from the monitoring devices 104 via the web server 110 in FIG. 1. The Peak column 354 shows the peak value of the displayed data over the period. The Date/Time at Peak column 356 shows the date and time where the value was at the peak value. The Date/Time Last Reset column 358 shows the time when the data was last reset.

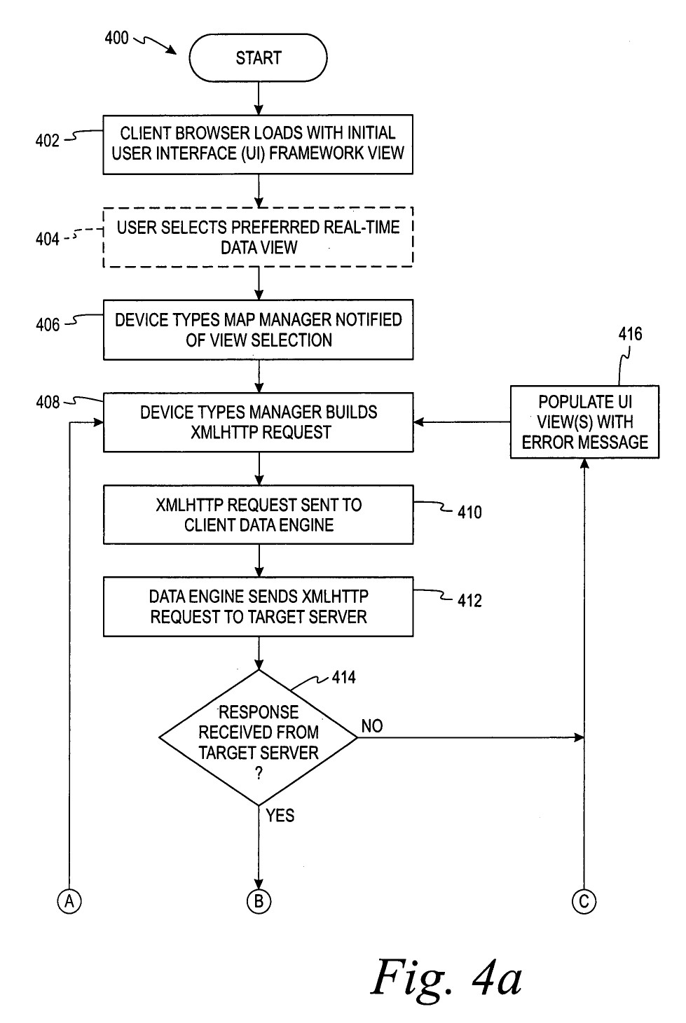

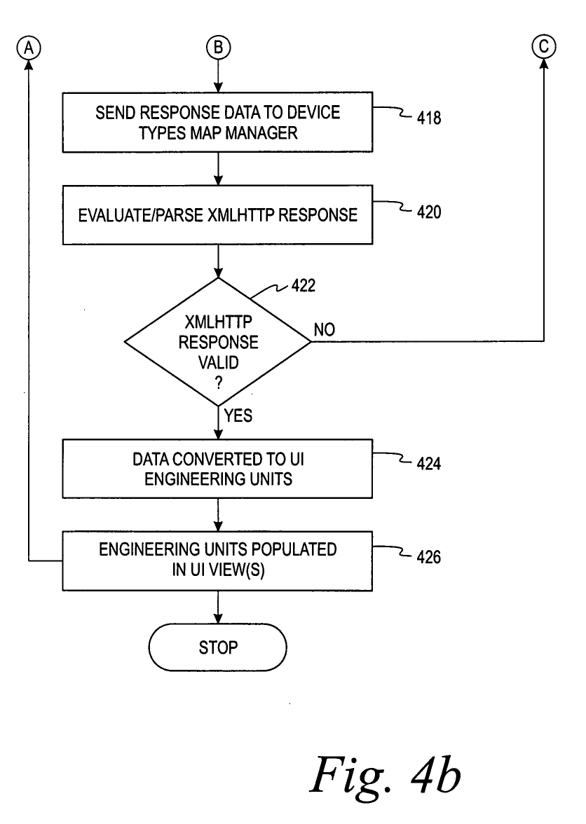

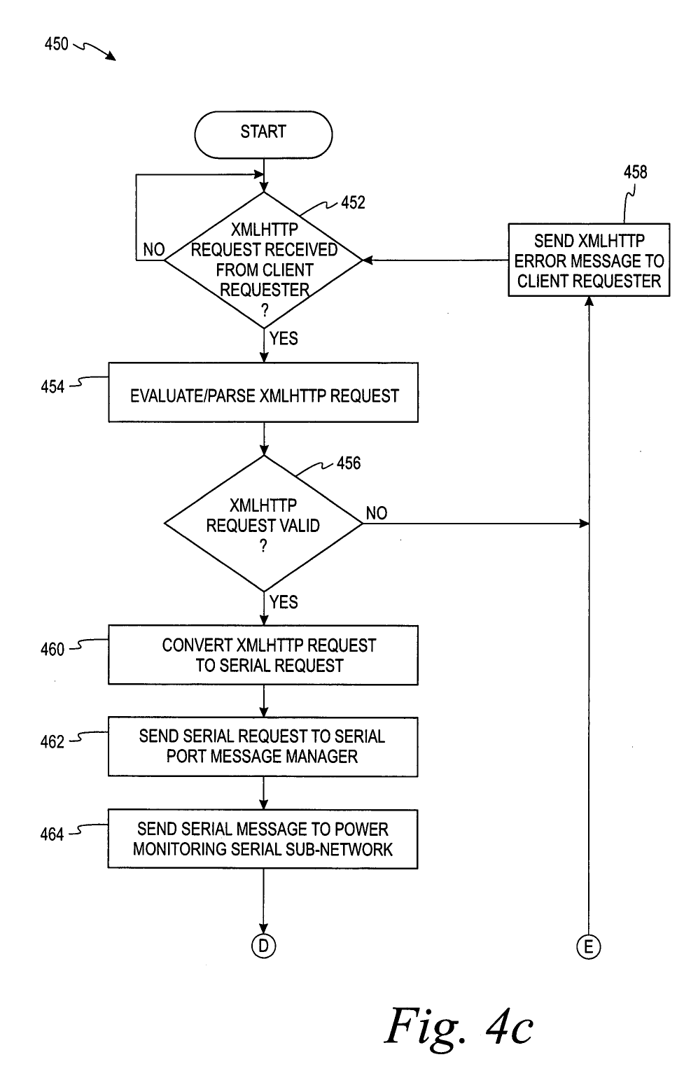

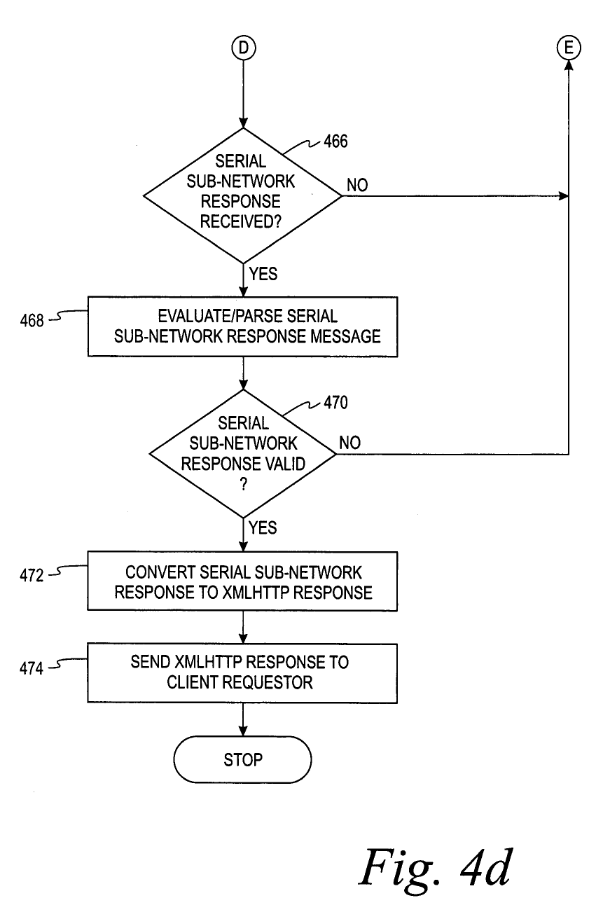

FIGS. 4A-4B and FIGS. 4C-4D are flow charts 400 and 450, respectively, representative of example machine readable instructions for implementing the processes managed by the power data monitoring system 100 of FIG. 1. In this example, the machine readable instructions comprise an algorithm for execution by: (a) a processor, (b) a controller, and/or (c) any other suitable processing device. The algorithm may be embodied in software stored on a tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a processor and/or embodied in firmware or dedicated hardware in a well known manner (e.g., it maybe implemented by an application specific integrated circuit (ASIC), a programmable logic device (PLD), a field programmable logic device (FPLD), discrete logic, etc.). Also, some or all of the machine readable instructions represented by the flowcharts of FIG. 4A-4D may be implemented manually. Further, although the example algorithm is described with reference to the flowcharts illustrated in FIGS. 4A-4D, persons of ordinary skill in the art will readily appreciate that many other methods of implementing the example machine readable instructions may alternatively be used. For example, the order of execution of the blocks may be changed, and/or some of the blocks described may be changed, eliminated, or combined.

FIGS. 4A-4B illustrate a client-side algorithm 400 for a process run by the client web-enabled device 114 shown in FIG. 1 for requesting and displaying real-time data. The client such as the client web-enabled device 114 connects to the network 112 via requesting the URL (uniform resource locator) belonging to the web server 110. The browser application on the client web-enabled device 114 loads the initial user interface in the form of a webpage from the web server 110 (402). The connection to the network 112 enables the web server 110 to send the client components 210, 212, 214, 216 and 218 described in FIG. 2 along with webpage data (e.g., Html, XML, CSS files) to the browser application on the client web-enabled device 114. Once the initial interface is loaded, the user is optionally prompted to select a preferred real-time data view (404). For example, selections may include data sensed from a particular monitoring device 104 or particular types of data as shown by the interface 300 described above in connection with FIG. 3. Of course many other data views may be selected by the user or may be automatically pre-selected by the client web-enabled device 114. The data view selection is read by the browser application and notifies the device types map manager 214 of the selection (406).

The device types map manager 214 builds a data request based on the XMLHttpRequest object (408). The device types map manager 214 sends the data request object to the client data engine component 210 (410). The client data engine component 210 sends the request object to the web server 110 via the TCP port 80 as explained above (412). The client data engine 210 determines whether a response is received from the web server 110 during a preset timeout period (414). If no response is received, the client data engine 210 sends an error message to the user interface framework display 216 to display an error message to the user (416). If a response is received from the web server 110, the client data engine 210 sends the response data to the device types map manager 214 (418).

The device types map manager 214 evaluates and parses the data that is attached to the XMLHttpRequest object returned (420). Based on that evaluation, the device types map manager 214 determines whether the data is valid by determining, for example, whether the data is in the expected format, matches the expected response, etc. (422). If the data is not valid, the process branches to (416) to display an error message on the user interface. If the data is valid at (422), the data is converted to user interface engineering units by the engineering units conversion component 218 (424). The formatted data is then populated in the user interface without reloading the components of the webpage (426).

FIGS. 4C-4D illustrate a server-side algorithm 450 carried out by the web server 110 to retrieve requested data from the web-enabled client. The server data engine 204 determines whether an XMLHttpRequest object has been received from a requesting client such as the client web-enabled device 114 in FIG. 1 (452). The request may be made on a periodic basis as determined by the data scheduler 212 or by specific request of a user of the client web-enabled device 114. When the request has been received, the server data engine 204 evaluates and parses the XMLHttpRequest object (454). Based on that evaluation, the server data engine 204 determines whether the request object is valid by determining, for example, whether the requested data is obtainable, in a recognizable format, etc. (456). If the data is not valid, the web server 10 sends an XMLHttp error message to the requesting client (458). The algorithm 450 returns to (452) to wait for another request. If the data is valid at (456), the data request is converted to a serial request by the server data engine 204 (460).

The serial request is passed to the serial port message manager 206 (462). The serial port message manager 206 sends a serial message to power monitoring devices 104 of the power monitoring subnetwork 202 in FIG. 2 via the serial communications lines connected to the power monitoring devices 104 (464). The serial port message manager 206 determines whether the monitoring device 104 has responded with the requested data (466). If no response is received from the power monitoring subnetwork 202, the web server 110 sends an XMLHttp error message to the requesting client (458). The algorithm 450 waits for another request (452).

If the request has been received from the monitoring device 104 (466), the serial port message manager 206 evaluates and parses the serial data (468) (FIG. 4D). Based on the evaluation, serial port message manager 206 determines whether the requested data is valid by determining, for example, whether the requested data is in the correct format, is responsive to the request, etc. (470). If the data is not valid, the web server 110 sends an XMLHttp error message to the requesting client (458). The algorithm 450 then waits for another request (452). If the data is valid (470), the requested data is converted to XML format and attached to a response to the XMLHttpRequest object by the server data engine 204 (472). The server data engine 204 sends the response to the requesting client (474). The process then returns to wait for another request (452).

While particular embodiments and applications of the present invention have been illustrated and described, it is to be understood that the invention is not limited to the precise construction and compositions disclosed herein and that various modifications, changes, and variations can be apparent from the foregoing descriptions without departing from the spirit and scope of the invention as defined in the appended claims.

What is claimed is:

1. A method of providing real-time data from an electrical power system via a web server to a web-based client, comprising:
accessing the web server to receive and load a webpage interface on the web-based client;
receiving, at the web server, power-related data from at least one power monitoring device in the electrical power system, the power-related data being representative of electrical characteristics sensed by the at least one power monitoring device;
communicating the power-related data over a network to the webpage interface; and
displaying the power-related data on the webpage interface without reloading the webpage from the web server.

2. The method of claim 1, wherein the power-related data is in an intermediate format, the method further comprising converting the format of the power-related data from the intermediate format to an extensible markup language (XML) format.

3. The method of claim 2, where the intermediate format is either Modbus, Jbus or SyMax formats.

4. The method of claim 1, wherein the power-related data is incorporated into an XMLHttpRequest object.

5. The method of claim 4, further comprising converting, in the web server, the power-related data into an XML format.

6. The method of claim 1, wherein the electrical characteristics are derived from at least one of voltage, current, or power data, the power-related data including at least one of voltage data, current data, or power data.

7. The method of claim 1, wherein the at least one power monitoring device is a plurality of power monitoring devices, and the webpage further displays a selection option to receive sensed data from any one of the plurality of power monitoring devices on the electrical power system.

8. The method of claim 1, wherein said communicating includes communicating the power-related data via an open port in the web-based client.

9. The method of claim 1, further comprising transferring a scheduler component from the web server, the scheduler component causing the web-based client to request data from the web server, which causes the at least one power monitoring device to communicate power-related data to the web server.

10. A web server to communicate real-time data between an electrical power system and a web based client, the electrical power system including a plurality of power monitoring devices, the web server comprising:
a data interface coupled to the plurality of power monitoring devices, the data interface receiving power-related data captured by at least one of the plurality of power monitoring devices in the electrical power system, the power-related data being representative of electrical characteristics sensed by the at least one of the plurality of power monitoring devices; and
a server data engine coupled to the data interface, the server data engine receiving the power-related data and transmitting a webpage interface to a requesting web client in network communication with the web server, wherein the web client displays the webpage interface and receives the power-related data from the web server after the web page interface is transmitted, the web page interface displaying the received power-related data without reloading the web page interface from the server data engine.

11. The web server of claim 10, wherein the web client includes a browser application.

12. The web server of claim 10, wherein the power-related data is communicated serially from the at least one of the plurality of monitoring devices in one of either Modbus, Jbus or SyMax formats.

13. The web server of claim 10, wherein the power-related data is incorporated into an XMLHttpRequest object.

14. The web server of claim 13, wherein the server data engine converts the power-related data to an XML format.

15. The web server of claim 10, wherein the webpage further displays a selection option to receive power-related data from any one of the plurality of monitoring devices of the electrical power system.

16. The web server of claim 10, wherein the server data engine transmits the power-related data through an open port.

17. The web server of claim 10, further comprising a scheduling component on the web client, the scheduling component requesting power-related data from the server data engine, which causes the at least one of the plurality of power monitoring devices to communicate power-related data to the data interface.

18. A web client application to obtain real-time data from a power monitoring system including a monitoring device, the application comprising:
a display interface to provide a user a graphic display including electrical data from the monitoring device; and
a client data engine coupled to the display interface, the client data engine receiving the electrical data via a remote web server coupled to the monitoring device, the client data engine providing the electrical data to the display interface without reloading the web interface.

19. The web client application of claim 18 further comprising a scheduler to request the electrical data from the remote web server on a periodic basis.

20. The web client application of claim 18, wherein the display interface includes a data request control, the data request control, when activated, causing the client data engine to request the electrical data from the monitoring device.

21. The web client application of claim 18, wherein the electrical data is received from the remote web server via an XMLHttpRequest object.
